(19) United States
(12) Patent Application Publication
(10) Pub. No.: US 2006/0214590 A1
(43) Pub. Date: Sep. 28, 2006

(54) Low-pressure gas discharge lamp with alkaline eart chalcogenides as electron emitter material

(75) Inventors: Rainer Hilbig, Aachen (DE); Robert Peter Scholl, Roetgen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/567,217

(22) PCT Filed: Jul. 28, 2004
(86) PCT No.: PCT/IB04/51308

§ 371 Date: Feb. 3, 2006

(30) Foreign Application Priority Data
Aug. 7, 2003 (EP) 03102467.2

(51) Int. Cl. H01J 61/12

(52) U.S. Cl. 313/637; 313/568; 313/318.01

(57) ABSTRACT

A description is given of a low-pressure gas discharge lamp equipped with a gas discharge vessel containing, as a buffer gas, an inert gas filling and an indium halogenide, thallium halogenide, gallium halogenide and/or copper halogenide, and with electrodes and means for generating and maintaining a low-pressure gas discharge, and which comprises one or more chalcogenides of alkaline earth metals as electron emitter material.

The invention relates to a low-pressure gas discharge lamp comprising a gas discharge vessel with a gas filling, electrodes and means for generating and maintaining a low-pressure gas discharge.

Light generation in low-pressure gas discharge lamps is based on the principle that charge carriers, particularly electrons but also ions, are accelerated so strongly by an electric field between the electrodes of the lamp that collisions with the gas atoms or molecules in the gas filling of the lamp cause these gas atoms or molecules to be excited or ionized. When the atoms or molecules of the gas filling return to the ground state, a more or less substantial part of the excitation energy is converted to radiation.

Conventional low-pressure gas discharge lamps comprise mercury in the gas filling and, in addition, a luminophor coating on the inside of the gas discharge vessel. A drawback of the mercury low-pressure gas discharge lamps resides in that mercury vapor primarily emits radiation in the high-energy, yet invisible UV-C range of the electromagnetic spectrum, which radiation must first be converted by luminophors to visible radiation with a much lower energy level. In this process, the energy difference is converted to undesirable thermal radiation.

In addition, the mercury in the gas filling is being regarded more and more as an environmentally harmful and toxic substance that should be avoided as much as possible in present-day mass-products as its use, production and disposal pose a threat to the environment.

It is known already that the spectrum of low-pressure gas discharge lamps can be influenced by substituting the mercury in the gas filling with other substances.

For example, German published patent applications DE 100 44 562, DE 100 44 563 and DE 101 28 915 disclose low-pressure gas discharge lamps containing a gas filling composed of a copper compound, an indium compound or a thallium compound together with an inert gas as a buffer gas. They are distinguished by a higher radiant efficacy in the visible range of the electromagnetic spectrum than conventional low-pressure gas discharge lamps. Besides, the visual efficacy can be further improved by the addition of additives and luminophors as well as by controlling the internal pressure of the lamp and the operating temperature.

In conventional low-pressure gas discharge lamps use is typically made of inner electrodes in the discharge lamp. In order to reduce the electron work function at these electrodes and hence the electric current coupling losses, use may be made of alkaline earth oxides or mixtures of alkaline earth oxides. For example U.S. Pat. No. 2,449,113 discloses the possibility of using alkaline earth oxides as electron emitter materials in electrodes.

In addition, it is also known, from International patent application WO 99/21213, to coat the electrodes of low-pressure gas discharge lamps with an electron emitter material composed of a mixture of alkaline earth oxides. By virtue thereof, the service life of such lamps is increased and the work function reduced.

In the case of low-pressure gas discharge lamps containing copper compounds, thallium compounds, gallium compounds or indium compounds in their gas filling, however, the hitherto customary alkaline earth oxide mixtures proved unsuitable for use as electron emitter materials. This can be attributed to the fact that they react with the alkaline earth oxides, for example in the manner shown in the following equation:
2 InBr+BaO→BaBr₂+In₂O

At the temperatures prevailing in the lamp this reaction also occurs if copper halogenides, thallium halogenides, gallium halogenides or indium halogenides are used. As a result, the radiating indium halogenides, thallium halogenides, gallium halogenides and copper halogenides disappear from the discharge, resulting in the generation of light becoming inefficient.

To date it has already been proven that indium halogenides do not react at all with chalcogenides such as MgS, Cas and/or SrS, and they react with BaS only at temperatures below 700 K. The reactivity of the chalcogenides of the alkaline earth metals with the halogenides fillings thus is clearly lower than that of the oxides of the alkaline earth metals.

In addition, it is already known from the literature that the electron work function Φ for the chalcogenides of the alkaline earth metals is much smaller than that of the oxides of the alkaline earth metals. For example, Φ(BaS)=2.6 eV and Φ(BaTe)=2.1-3.9 eV.

Therefore it is an object of the invention to utilize the electron emitter properties of chalcogenides of the alkaline earth metals, such as Mg, Ca, Sr and/or Ba, for low pressure gas discharge lamps containing indium halogenides, thallium halogenides, gallium halogenides or copper halogenides in the gas filling.

In accordance with the invention, this object is achieved by a low-pressure gas discharge lamp equipped with a gas discharge vessel containing, as a buffer gas, an inert gas filling and an indium halogenide, thallium halogenide, gallium halogenide and/or copper halogenide, and with electrodes and means for generating and maintaining a low-pressure gas discharge, and which comprises one or more chalcogenides of alkaline earth metals as electron emitter material.

The low-pressure gas discharge lamp in accordance with the invention contains, as a buffer gas, an inert gas of the group formed by helium, neon, argon, krypton and xenon. The cold pressure of the inert gas advantageously ranges from 1 to 100 mbar, in particular from 1.5 to 3.0 mbar.

In the lamp in accordance with the invention, a molecular gas discharge takes place at a low pressure, which gas discharge emits radiation in the visible and near UVA range of the electromagnetic spectrum. To convert the UV light to visible light, use is made of luminophors which are applied to the inside and/or outside of the discharge vessel. These luminophors or combinations of luminophors do not necessarily have to be applied to the inside of the gas discharge vessel, but may alternatively be applied to the outside as the generated radiation in the WVA range is not absorbed by the materials customarily used for the walls of the discharge vessel. The materials that may suitably be used as luminophors must absorb the generated radiation and emit said radiation in a suitable wavelength range.

1. A low-pressure gas discharge lamp equipped with a gas discharge vessel containing, as a buffer gas, an inert gas filling and an indium halogenide, thallium halogenide, gallium halogenide and/or copper halogenides, and with electrodes and means for generating and maintaining a low-pressure gas discharge, characterized in that said low-pressure gas discharge lamp comprises one or more chalcogenides of alkaline earth metals as electron emitter material.

2. A low-pressure gas discharge lamp as claimed in claim 1, characterized in that the chalcogenide is selected from the group formed by sulphides, selenides and/or tellurides.

3. A low-pressure gas discharge lamp as claimed in claim 1, characterized in that it contains, as a buffer gas, an inert gas selected from the group formed by helium, neon, argon, krypton and xenon.

4. A low-pressure gas discharge lamp as claimed in claim 1, characterized in that the gas discharge vessel comprises a luminophor coating applied to the inside and/or the outside.

5. The use of one or more chalcogenides of alkaline earth metals as electron emitter material for coating electrodes in discharge lamps.
